(19) United States
(12) Patent Application Publication
(10) Pub. No.: US 2007/0174784 A1
(43) Pub. Date: Jul. 26, 2007

(54) Method for presenting objects of the windows operating environment on multiple display devices

(75) Inventors: Pao-Ta Yu, Taipei County (TW); Yuan-Hou Chang, Taipei County (TW)

Correspondence Address: BIRCH STEWART KOLASCH & BIRCH, PO BOX 747, FALLS CHURCH, VA, 22040-0747, US

(73) Assignee: Tangtake Technology Co., Ltd.

(21) Appl. No.: 11/408,954

(22) Filed: Apr. 24, 2006

(30) Foreign Application Priority Data
Jan. 26, 2006 (TW) 095102969

(51) Int. Cl. G06F 17/00

(52) U.S. Cl. 715/799

(57) ABSTRACT

The present invention discloses a method for presenting objects of the Windows operating environment on multiple display devices, which is implemented with a series of computer-executable steps, wherein the attribute values of the display regions of multiple display devices (such as the resolutions thereof) and the attribute values of at least one object of the Windows operating environment are used to redefine a restricted display region that may cross multiple display device; via coordinatizing the objects and the display regions of the display devices, the fiducial coordinates of the objects can be moved to the assigned display coordinates inside the restricted display region to present the objects on within the restricted display region. Thereby, the objects can only be moved within the assigned display region of the screens, and the existing/uncreated objects can be moved/assigned to the intended positions or regions.

### FIELD OF THE INVENTION

The present invention relates to a method for presenting objects, particularly to a method for presenting objects of the Windows operating environment on multiple display devices.

### BACKGROUND OF THE INVENTION

The TV-wall technology, which utilizes multiple TV screens to present an integral picture, has been established and well known to people for a long time.

Traditionally, the computer-display connection relationship is usually one-to-one. When multiple Windows objects are created, only the topmost-layer object or the on-focus object can be viewed, and the other Windows objects are covered by the abovementioned objects. Thus, the user has to constantly shift Windows objects to view the desired object, and it is pretty troublesome for the user. Therefore, some conventional technologies proposed schemes to solve the abovementioned problems, including Taiwan patents of Patent No. 1228703, 594556, and 539959, and Taiwan patents of Publication No. 200539028, 200529008, and 200519734. The commonness thereof is to present multiple Windows objects on a single display screen. Although all the abovementioned patents can achieve the objective of present multiple Windows objects on a single display screen, each Windows object becomes relatively smaller, which will beset the narrator and audience of a brief presentation.

There is further a conventional technology, which implements one-to-multiple computer-display connection relationship and can respectively present multiple Windows objects on multiple display screens. However, such a technology needs a special display card, and the user has to replace the original common display card with the special card. The utility thereof is lowered. Besides, such a technology lacks the mechanism of assigning other necessary objects implemented the Windows operating environment, such as a cursor and a toolbar, i.e. it lacks the cooperation of editing softwares. Therefore, the function thereof is incomplete.

### SUMMARY OF THE INVENTION

The primary objective of the present invention is to provide a method for presenting objects of the Windows operating environment on multiple display devices, which does not need any special display card but only uses a common display card and a series of computer-executable procedures, wherein the objects can only be moved within the assigned display region of display screens, and the existing/uncreated objects can be moved/assigned to specified positions or regions.

To achieve the abovementioned objective, the present invention proposes a method for presenting objects of the Windows operating environment on multiple display devices, which essentially comprises the following steps: obtaining and recording the attribute values of the display regions of multiple display devices, including the resolutions of the display devices (PIXELS); redefining a restricted display region according to the resolutions of the display devices, and assigning the origin to the restricted display region; redefining the pixel coordinates of the display regions of the display devices according to the origin of the restricted display region, and recording the new coordinates of the pixels; obtaining and recording the attribute values of at least one object of the Windows operating environment, including a fiducial coordinate of the object; allocating an assigned display coordinate inside the restricted display region to the object; and moving the fiducial coordinate of the object to the assigned display coordinate so that the object can be presented on within the restricted display region.

### BRIEF DESCRIPTION OF THE DRAWINGS

FIG. 1 is a flowchart showing the method for presenting objects of the Windows operating environment on multiple display devices according to the primary conception of the present invention.

FIG. 2A and FIG. 2B are diagrams schematically showing a preferred embodiment implementing the primary conception of the present invention.

FIG. 2C is a diagram schematically showing another preferred embodiment implementing the primary conception of the present invention.

FIG. 3 is a diagram schematically showing other embodiments of the objects of the Windows operating environment.

FIG. 4 is a flowchart showing a preferred embodiment implementing the primary conception of the present invention.

FIG. 5 is a flowchart showing the embodiment of the checklist-establishing procedure.

FIG. 6 is a flowchart showing the embodiment of the OS-message-waiting procedure.

FIG. 7 is a flowchart showing the embodiment of the object-checking procedure.

FIG. 8 is a flowchart showing the embodiment of the procedure of removing an object for the checklist.

FIG. 9 is a flowchart showing the embodiment of the procedure of periodically checking (querying) checklist.

### DETAILED DESCRIPTION OF THE PREFERRED EMBODIMENTS

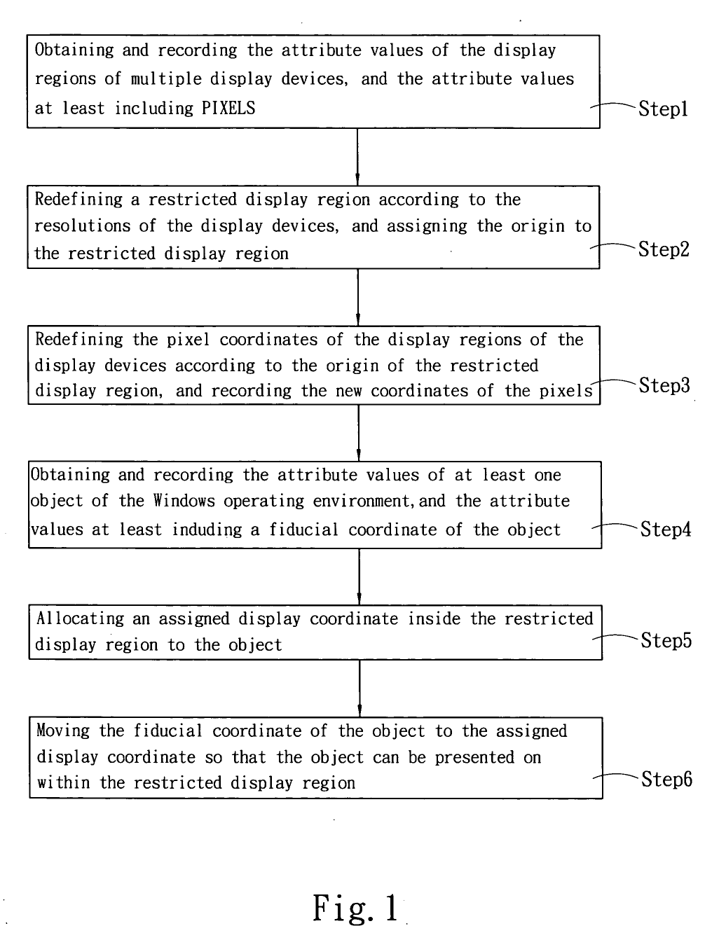

Refer to FIG. 1 a flowchart showing the method for presenting objects of the Windows operating environment on multiple display devices according to the primary conception of the present invention. The method of the present invention can be implemented with the following computer (a personal computer or a notebook computer)-executable steps, which comprise:
Step 1: obtaining and recording the attribute values of the display regions of multiple display devices, including the resolutions (PIXELS) of the display devices, wherein the display device is not limited to but may be the device selected from the group consisting of monitor, projector, and LCD (Liquid Crystal Display);
Step 2: redefining a restricted display region according to the resolutions of the display devices, and assigning the origin to the restricted display region;
Step 3: redefining the pixel coordinates of the display regions of the display devices according to the origin of the restricted display region, and recording the new coordinates of the pixels;
Step 4: obtaining and recording the attribute values of at least one object of the Windows operating environment, including a fiducial coordinate of the object, wherein the object is not limited to but may be the item selected from the group of graphic interface, cursor, and Windows object, and the attribute value of the object is not limited to but may be the item selected from the group consisting of the size of the object and the proportion of the object dimensions;
Step 5: allocating an assigned display coordinate inside the restricted display region to the object; and
Step 6: moving the fiducial coordinate of the object to the assigned display coordinate so that the object can be presented on within the restricted display region.

The abovementioned steps are to be further clarified below in cooperation with the diagrams. Refer to FIG. 1 again, and refer to

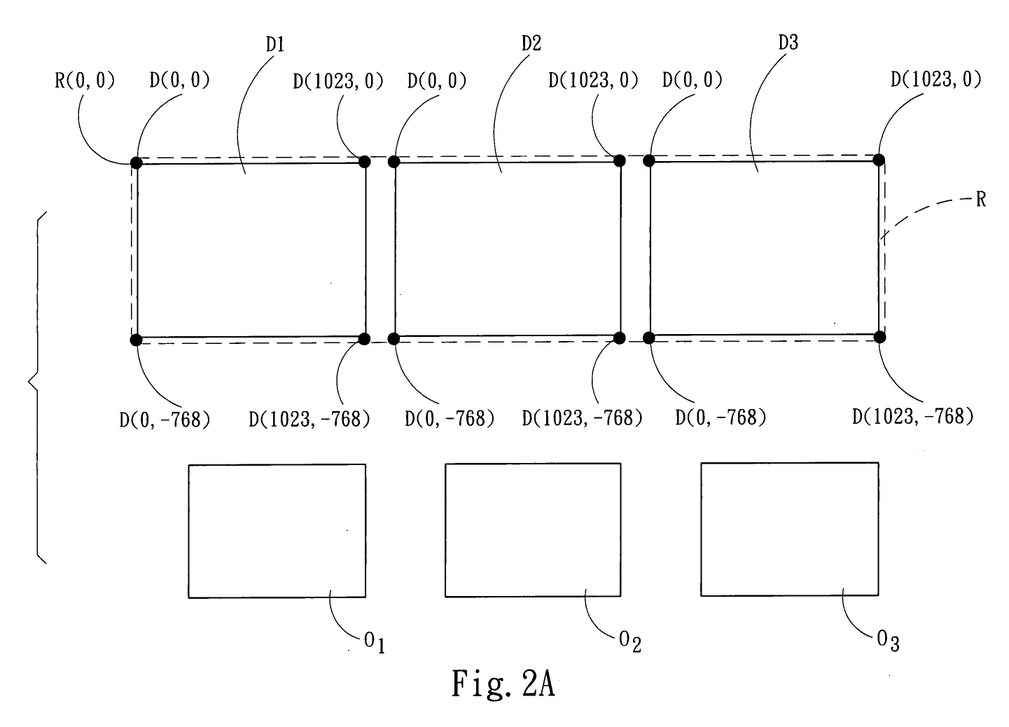

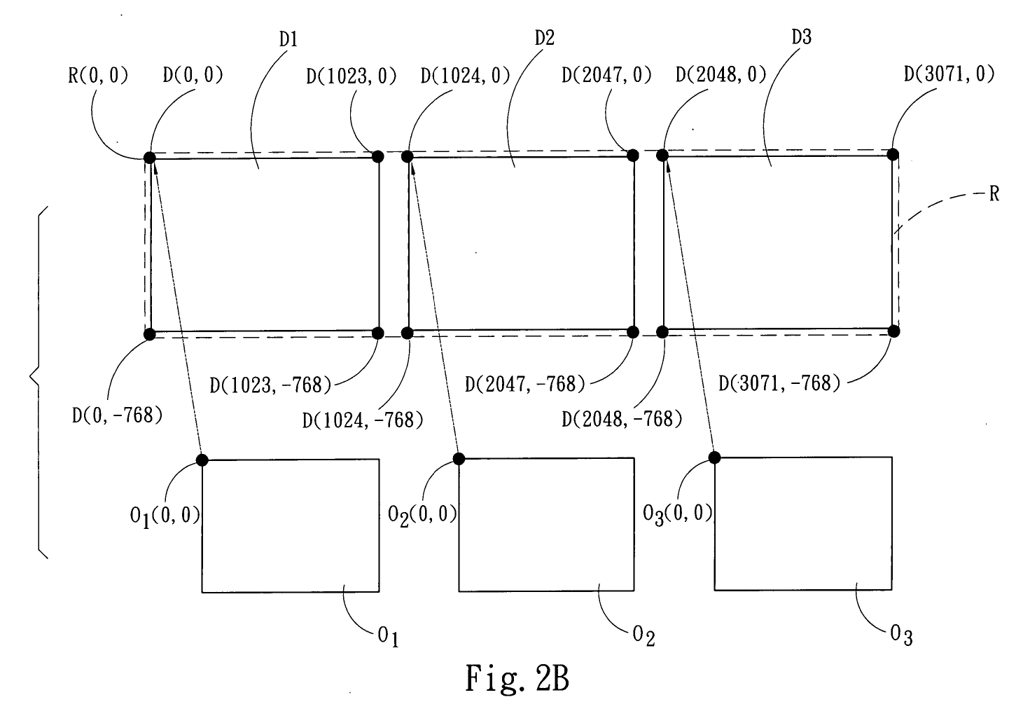

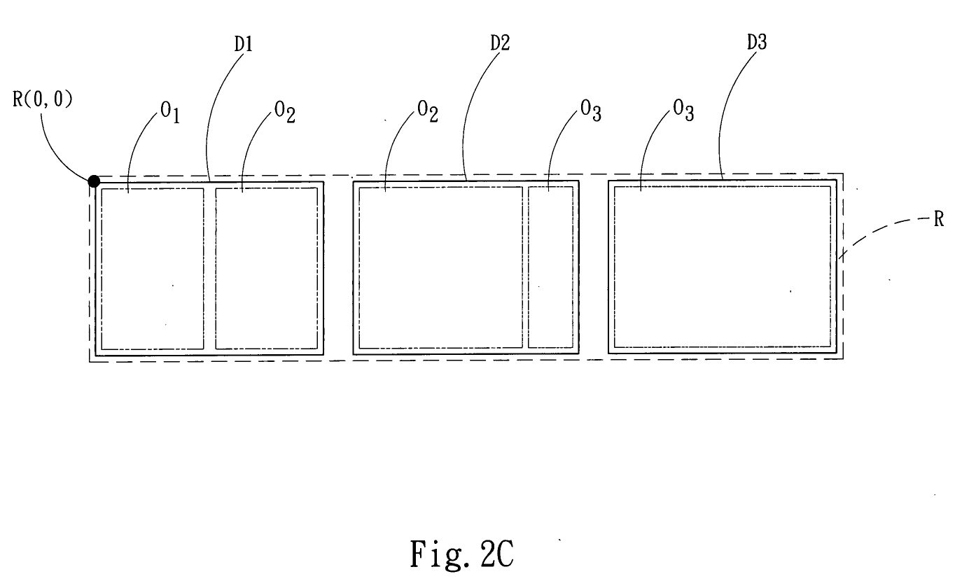

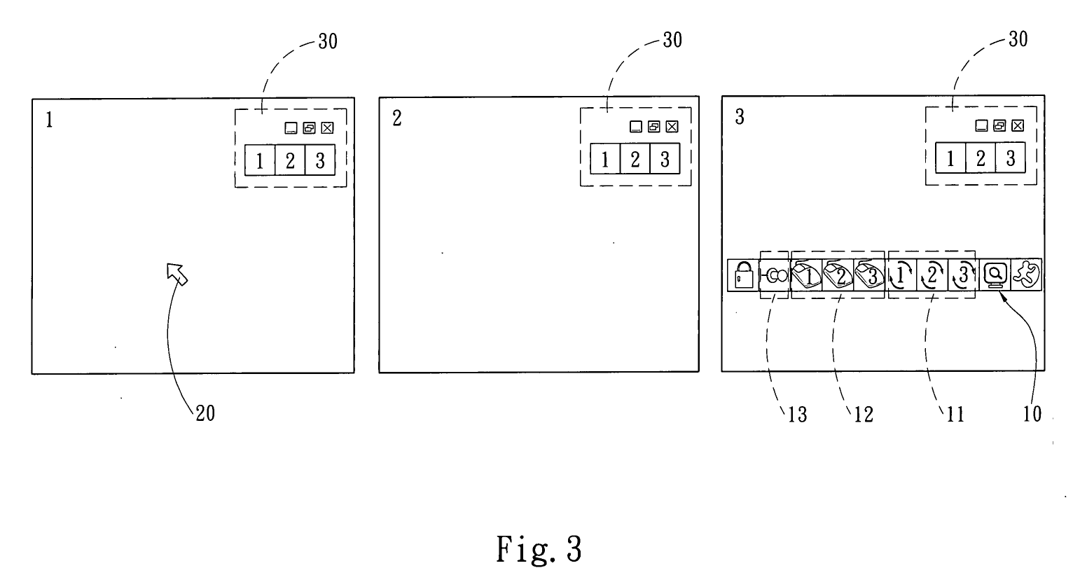

FIG. 2A and FIG. 2B. As shown in FIG. 2A, three Windows objects O₁, O₂, and O₃ of the Windows operating environment are intended to respectively present on the display regions D₁, D₂, and D₃ of three display devices. In Step 1, the resolutions of the display regions D₁, D₂, and D₃of the display devices are obtained and recorded, i.e. the display regions D₁, D₂, and D₃ are coordinatized with the pixels inside the display regions D₁, D₂, and D₃. Suppose the resolution of each display region is 1024×768(pixels), and let the left upper corner of each of the display regions D₁, D₂, and D₃ be the origin. After the coordinatization, the coordinates of the left lower corner, the right upper corner, and the right lower corner of the display region of each display device will be D(0,−768), D(1023,0), and D(1023,−768) respectively. In Step 2, a restricted display region R, which contains the display regions D₁, D₂, and D₃ of the display devices, is redefined according to the resolutions of the display devices, and assigning the origin R(0,0) to the restricted display region R, such as to the left upper corner of the restricted display region R. In Step 3, the coordinates of the pixels of the display regions D₁, D₂, and D₃ of the display devices are redefined according to the origin R(0,0) of the restricted display region R, and the new coordinates of the pixels are recorded. After the coordinate redefinition, the coordinates of the left upper corner, the left lower corner, the right upper corner, and the right lower corner of the display region of the central display device will be D(1024,0), D(1024,−768), D(2047,0), and D(2047,−768) respectively; the coordinates of the left upper corner, the left lower corner, the right upper corner, and the right lower corner of the display region of the right display device will be D(2048,0), D(2048,−768), D(3071,0), and D(3071,−768) respectively. In Step 4, three fiducial coordinates O₁(0,0), O₂(0,0), and O₃(0,0) are respectively obtained from the abovementioned Windows objects O₁, O₂, and O₃ of the Windows operating environment. In Step 5, three assigned display coordinates, such as D(0,0), D(1024,0), and D(2048,0), are respectively allocated to three abovementioned Windows objects O₁, O₂, and O₃. In Step 6, the fiducial coordinates O₁(0,0), O₂(0,0), and O₃(0,0) of three abovementioned Windows objects O₁, O₂, and O₃ are moved to three abovementioned assigned display coordinates D(0,0), D(1024,0), and D(2048,0) so that three abovementioned Windows objects O₁, O₂, and O₃ can be presented on within the restricted display region R. In other words, three Windows objects O₁, O₂, and O₃ can exactly fulfill the display regions D₁, D₂, and D₃ of those three display devices respectively. However, the allocation modes that the Windows objects O₁, O₂, and O₃ are allocated to the display regions D₁, D₂, and D₃ of those three display devices is not limited to one-to-one. As shown in FIG. 3C, similar to the TV wall conception that multiple sub-pictures are assembled into a complete picture, the Windows object O₁, O₂, or O₃ may also be allocated to the partial area or the full area of the display region D₁, D₂, or D₃. Besides, the restricted display region R is not constrained by physical display devices, i.e. the restricted display region R may be either limited to a single display device or across multiple display devices.

In the present invention, the Windows object is not limited to those shown in FIG. 2A and FIG. 2B but may also be a graphic interface, such as a toolbar 10 or a cursor 20 shown in FIG. 3. There are three icons 11, 12, and 13 in the toolbar 10. When the user clicks on one of buttons 1, 2, and 3 of the icon 11, the cursor 20 will jump to the intended display device. When the user clicks on one of buttons 1, 2, and 3 of the icon 12, the mouse will obtain the control power over the intended display device. When the user clicks on the icon 13, a small icon 30 will appear on the corner of each display device. When the user clicks on one of buttons 1, 2, and 3 of the icon 30, he can move the intended file, such as a Word file, an Excel file, or a Powerpoint file on the Windows, to the intended display device.

However, those disclosed in FIG. 2A and FIG. 2B are only used to exemplify the conception of the present invention. The persons skilled in the art should understand that the resolution of the Windows object is not necessarily equal to that of the display region of the display device. Thus, an adjustment process may be needed. An implemental process will be disclosed below to cooperate with the main process of the present invention.

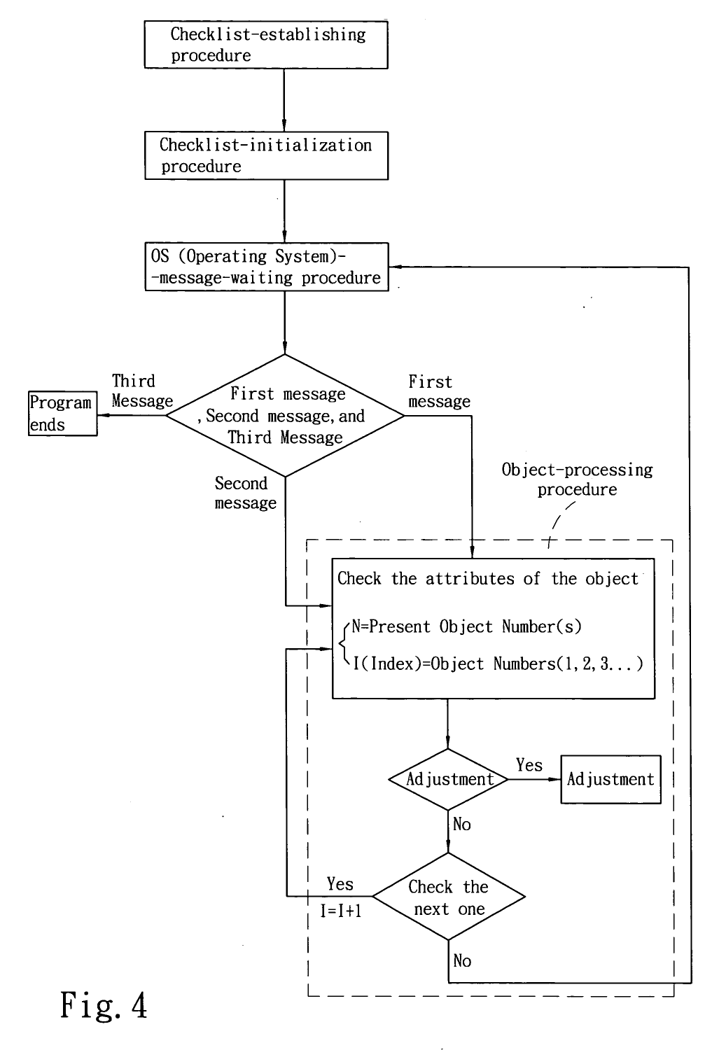

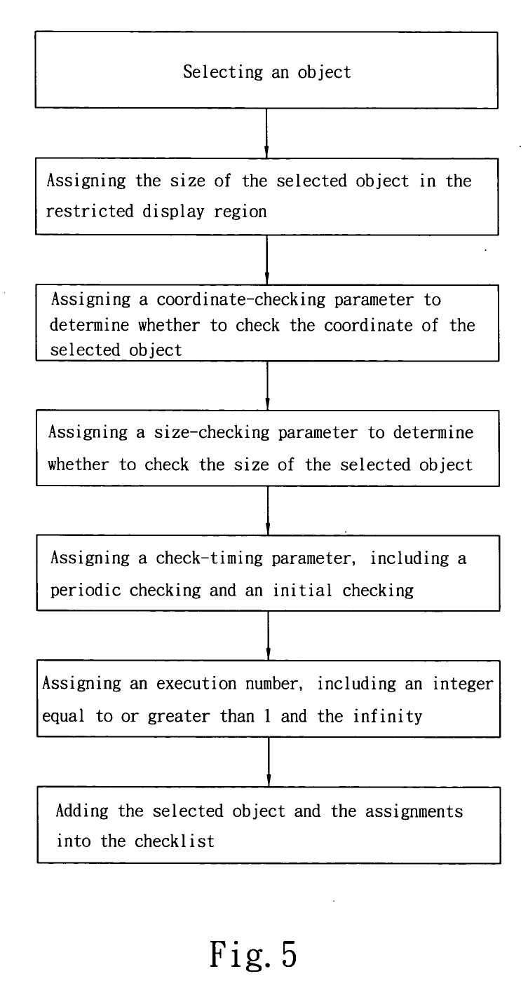

Refer to FIG. 4 a flowchart of the process according to a preferred embodiment of the present invention. Firstly, a checklist-establishing procedure is performed. As shown in FIG. 5, the checklist-establishing procedure comprises the following steps: selecting an object; assigning the size of the selected object in the restricted display region; assigning a coordinate-checking parameter to determine whether to check the coordinate of the selected object; assigning a size-checking parameter to determine whether to check the size of the selected object; assigning a check-timing parameter, including a periodic checking and an initial checking; assigning an execution number, including an integer equal to or greater than 1 and the infinity; and adding the selected object and the assignments into the checklist.

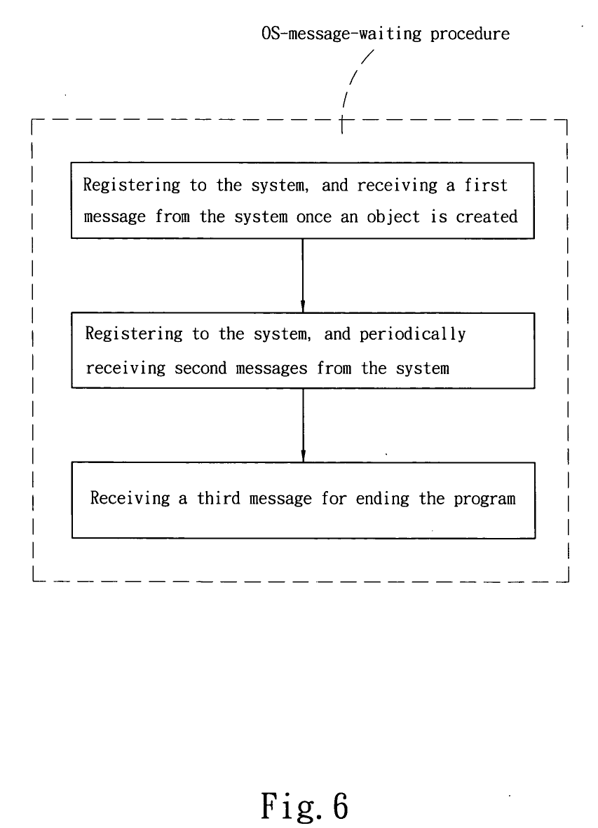

After the checklist-establishing procedure has been executed, a checklist-initialization procedure and then an OS (Operating System)-message-waiting procedure follow. The messages received in the OS-message-waiting procedure include: a first message received from the operating system once an object is created; second messages periodically received from the operating system; and a third message for ending the program. Refer to FIG. 6 for a more detailed description of the abovementioned OS-message-waiting procedure. The OS-message-waiting procedure comprises the following steps: registering to the system, and receiving a first message from the system once an object is created; registering to the system, and periodically receiving second messages from the system; and receiving a third message for ending the program.

When the message received in the OS-message-waiting procedure is the first message or the second message, an object-processing procedure will be executed to check the attributes of the object, including executing an object-size-checking program and executing a checking program to determine whether the object is removed from the restricted display region. Next, execute a step to determine whether an adjustment is needed. If the determination is “Yes”, the adjustment is executed. If the determination is “No”, execute a step to determine whether the next one is to be checked. If the determination is “Yes”, the process returns to the attribute-checking procedure. If the determination is “No”, the process returns to the OS-message-waiting procedure. No matter which one of the first message and the second message is received in the OS-message-waiting procedure, the abovementioned object-processing procedure is to be executed. However, the first message denotes that a new created object is in the checklist, and that the checking timing is the initial appearance of the object. The second message is to periodically check the checklist. To speak briefly, the first message and the second message are different in the checking timing.

When the message received in the OS-message-waiting procedure is the third message, the process does not return to the OS-message-waiting procedure but ends the program directly.

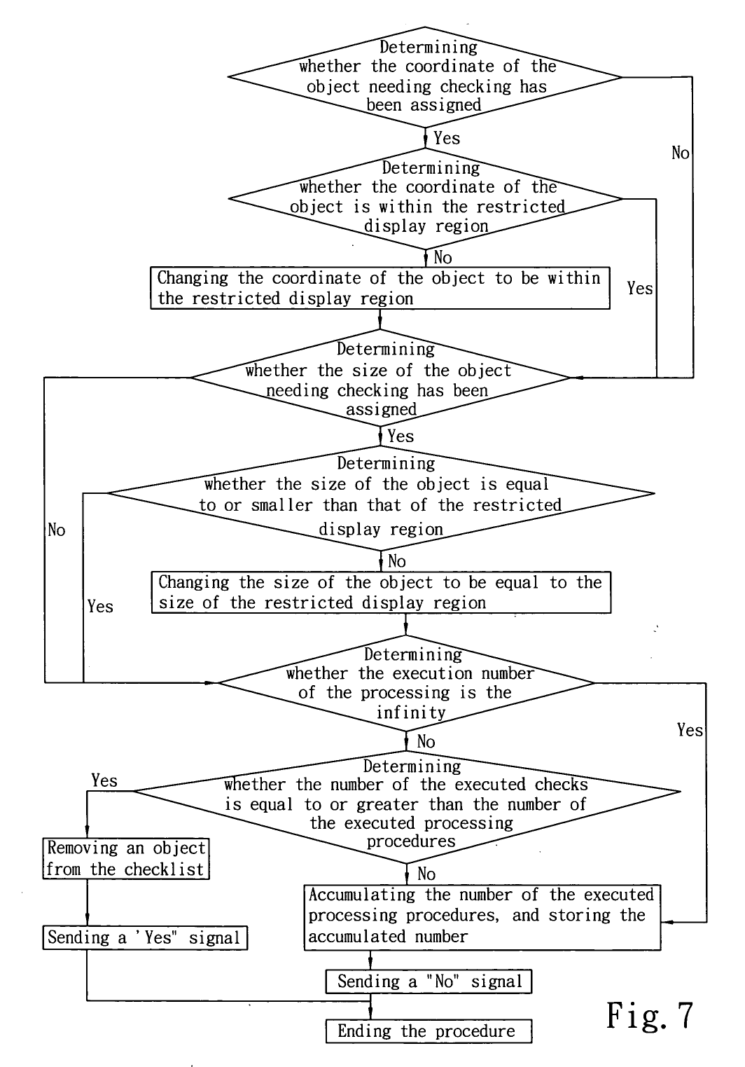

As shown in FIG. 7, the object-processing procedure can be further divided into fourteen steps:
Step 1: determining whether the coordinate of the object needing checking has been assigned (If it is Yes, the process proceeds to Step 2; if it is No, the process jumps to Step 4.);
Step 2: determining whether the coordinate of the object is within the restricted display region (If it is Yes, the process jumps to Step 4; if it is No, the process proceeds to Step 3.);
Step 3: changing the coordinate of the object to be within the restricted display region;
Step 4: determining whether the size of the object needing checking has been assigned (If it is Yes, the process jumps to Step 7; if it is No, the process proceeds to Step 5.);
Step 5: determining whether the size of the object is equal to or smaller than that of the restricted display region (If it is Yes, the process jumps to Step 7; if it is No, the process proceeds to Step 6.);
Step 6: changing the size of the object to be equal to the size of the restricted display region;
Step 7: determining whether the execution number of the processing is the infinity (If it is Yes, the process jumps to Step 13; if it is No, the process proceeds to Step 8.);
Step 8: determining whether the number of the executed checks is equal to or greater than the number of the executed processing procedures (If it is Yes, the process proceeds to Step 9; if it is No, the process jumps to Step 13.);
Step 9: removing an object from the checklist;
Step 10: sending a “Yes” signal;
Step 11: jumping to Step 14;
Step 12: accumulating the number of the executed processing procedures, and storing the accumulated number;
Step 13: sending a “No” signal; and
Step 14: ending the procedure.

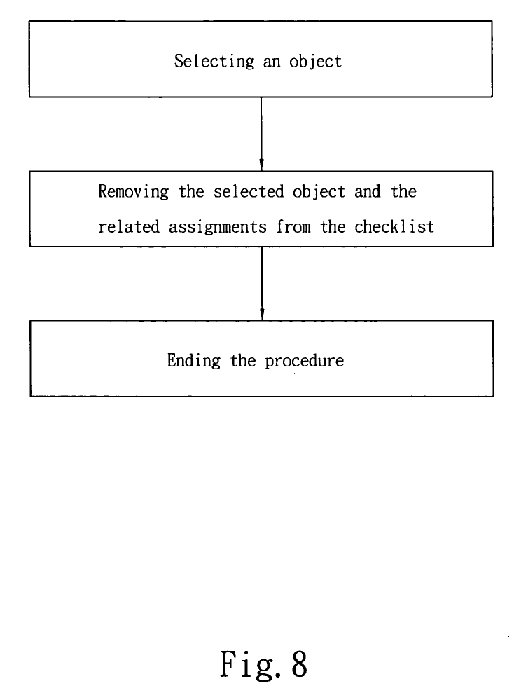

As shown in FIG. 8, the abovementioned step of removing an object from the checklist can be further divided into three steps:
Step 1: selecting an object;
Step 2: removing the selected object and the related assignments from the checklist; and
Step 3: ending the procedure.

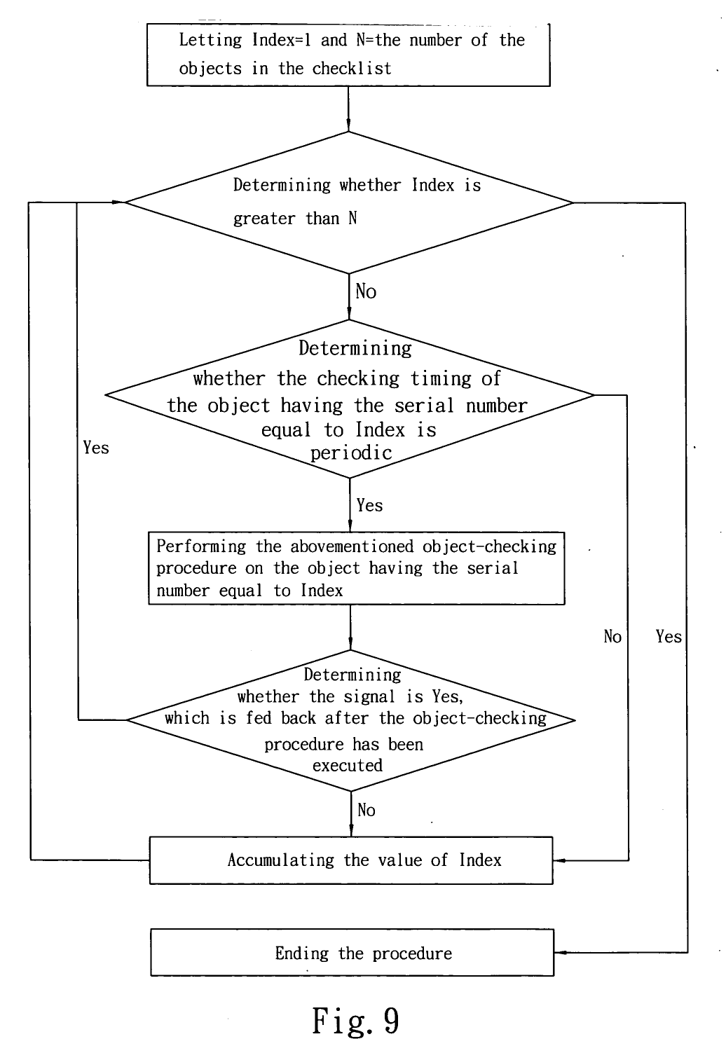

As shown in FIG. 9, the step of periodically checking the checklist in the object-processing procedure can be further divided into eight steps:
Step 1: letting Index=1 and N=the number of the objects in the checklist;
Step 2: determining whether Index is greater than N (If it is Yes, the process jumps to Step 8; if it is No, the process proceeds to Step 3.);
Step 3: determining whether the checking timing of the object having the serial number equal to Index is periodic (If it is Yes, the process jumps to Step 5; if it is No, the process proceeds to Step 4.);
Step 4: performing the abovementioned object-checking procedure on the object having the serial number equal to Index;
Step 5: determining whether the signal is Yes, which is fed back after the object-checking procedure has been executed (If it is Yes, the process jumps to Step 2; if it is No, the process proceeds to Step 6.);
Step 6: accumulating the value of Index;
Step 7: jumping to Step 2; and
Step 8: ending the procedure.

In summary, the display method of the present invention can present at least one object of the Windows operating environment on multiple display devices. To speak in detail, when the display method of the present invention is applied to a brief presentation system, the user can respectively present multiple Windows objects of the Windows operating environment on multiple assigned display devices via the display method of the present invention, wherein the Windows objects include: Word files, Powerpoint files, JPG files, Excel files, WMV files, and IE objects. The Windows objects also include: existing Windows objects, uncreated Windows objects, visible Windows objects, and invisible Windows objects. Further, the cursor and graphic interfaces of the Windows operating environment can also be presented on the assigned display devices. Thereby, not only multiple files of a brief presentation can be simultaneously viewed, but also the brief presentation may have picture, voice, animation, and video functions. Therefore, the brief presentation will be more convenient, vivid, and prompt. Further, it should be known by the persons skilled in the art that the application fields of the display method of the present invention is not limited to brief presentations but may also comprise: public bulletins, meetings, activities, shows, business, teachings and trainings.

The preferred embodiments of the present invention have been described above to clarify the present invention; however, it is not intended to limit the scope of the present invention, and any equivalent modification and variation according to the spirit of the present invention is to be also included within the scope of the claims stated below.

What is claimed is:

1. A method for presenting objects of the Windows operating environment on multiple display devices, implemented with a computer program according to the following computer-executable steps:
obtaining and recording the attribute values of the display regions of multiple display devices, including the resolutions of said display devices (PIXELS);
redefining a restricted display region according to the resolutions of said display devices, and assigning the origin to said restricted display region;
redefining the pixel coordinates of said display regions of said display devices according to said origin of said restricted display region, and recording the new coordinates of said pixels;
obtaining and recording the attribute values of at least one object of the Windows operating environment, including a fiducial coordinate of said object;
allocating an assigned display coordinate inside said restricted display region to said object; and
moving said fiducial coordinate of said object to said assigned display coordinate so that said object can be presented on within said restricted display region.

2. The method for presenting objects of the Windows operating environment on multiple display devices according to claim 1, further comprising a checklist-establishing process before the step of obtaining and recording the attribute values of said display regions of said display devices, wherein said checklist-establishing process comprises the following steps:
selecting said object;
assigning the size of said object in said restricted display region;
assigning a coordinate-checking parameter to determine whether to check the coordinate of said object;
assigning a size-checking parameter to determine whether to check the size of said object;
assigning a check-timing parameter, including a periodic checking and an initial checking;
assigning an execution number, including an integer equal to or greater than 1 and the infinity; and
adding said object and the abovementioned assignments into said checklist.

3. The method for presenting objects of the Windows operating environment on multiple display devices according to claim 2, further comprising two procedures after said checklist-establishing process, wherein said two procedures includes:
initializing said checklist; and
waiting OS (Operating System) messages.

4. The method for presenting objects of the Windows operating environment on multiple display devices according to claim 3, wherein said procedure of waiting OS messages includes the following steps:
receiving a first message from said operating system once an object is created;
periodically receiving second messages from said operating system; and
receiving a third message for ending the program.

5. The method for presenting objects of the Windows operating environment on multiple display devices according to claim 4, wherein if the message received in said procedure of waiting OS messages is said first message, an object-processing procedure is executed, and it is checked whether a new created object exists in said checklist, and the checking is an initial checking; if the received message is not said first message, the process will return to said procedure of waiting OS messages.

6. The method for presenting objects of the Windows operating environment on multiple display devices according to claim 5, wherein said object-processing procedure includes the following steps:
executing an object-position-checking program;
executing an object-size-checking program; and
executing a program to determine whether said object is moved out of said restricted display region.

7. The method for presenting objects of the Windows operating environment on multiple display devices according to claim 6, wherein when the message received in said procedure of waiting OS messages is said second message, said object-processing procedure is executed at a specified timing; if the received message is not said second message, the process will return to said procedure of waiting OS messages.

8. The method for presenting objects of the Windows operating environment on multiple display devices according to claim 4, wherein when the message received in said procedure of waiting OS messages is said third message, the process will not return to said procedure of waiting OS messages but ends the program.

9. The method for presenting objects of the Windows operating environment on multiple display devices according to claim 1, wherein the attribute values of said object is not limited to but may include: the size of said object and the proportion of the dimensions of said object.

10. The method for presenting objects of the Windows operating environment on multiple display devices according to claim 1, wherein said restricted display region is not limited to but may be selected from: the display region of a single display device and the combination of the display regions of multiple display devices.

11. The method for presenting objects of the Windows operating environment on multiple display devices according to claim 1, wherein said object is not limited to but may be selected from the group consisting of cursor, graphic interface, and Windows object.

12. The method for presenting objects of the Windows operating environment on multiple display devices according to claim 1, wherein said display device is not limited to but may be selected from the group consisting of screen, projector, and liquid crystal display.
